(19) United States
(12) Patent Application Publication
(10) Pub. No.: US 2021/0043372 A1
(43) Pub. Date: Feb. 11, 2021

(54) POT CORE TRANSFORMER WITH MAGNETIC SHUNT

(71) Applicant: THERMO SCIENTIFIC PORTABLE ANALYTICAL INSTRUMENTS INC., Tewksbury, MA (US)

(72) Inventor: Mark Dinsmore, Colorado Springs, CO (US)

(21) Appl. No.: 16/947,503

(22) Filed: Aug. 4, 2020

Related U.S. Application Data
(60) Provisional application No. 62/882,705, filed on Aug. 5, 2019.

(51) Int. Cl. H01F 27/38; H01F 27/24

(52) U.S. Cl. CPC H01F 27/38; H01F 27/24

(57) ABSTRACT

A pot core transformer assembly includes a multiplier comprising a pair of single layer capacitors connected by a pair of high voltage diodes. A pot core transformer is connected in series with the multiplier, and includes a first core half having a first projection, and a second core half having a second projection spaced from the first projection by a first gap. A primary winding is wrapped about the first projection, and a secondary winding wrapped about the second projection. A magnetic shunt is positioned between the first core half and the second core half, and includes a central aperture receiving a portion of the first projection and a portion of the second projection. A second gap is formed between an outer peripheral surface of the magnetic shunt and an interior surface of the first core half and an interior surface of the second core half.

### CROSS-REFERENCE TO RELATED APPLICATIONS

The present application claims the priority benefit from U.S. Patent Application Ser. No. 62/882,705, filed Aug. 5, 2019, which is hereby incorporated by reference herein in its entirety for all purposes.

### FIELD

Aspects of this disclosure relate generally to a pot core transformer, and more particularly, a pot core transformer including a magnetic shunt.

### BACKGROUND

The size of portable handheld X-ray fluorescence testing systems have been reduced over time, and this reduction in size has required miniaturization of the sources that generate the exciting X-rays to produce the X-ray fluorescence. Conventional transformer/Cockcroft Walton high voltage multipliers are known, but it is to be appreciated that miniaturization of the systems creates several new challenges for the high voltage power supply. Battery operation of these systems demands that the efficiency be very high to provide long battery life, and the decreased size can create challenges with respect to heat dissipation. The reduced size also introduces challenges that include less room for insulation, closer coupling between the components, and the need to use smaller gauge wire. Increasing sensitivity of the X-ray detector systems requires that the power supplies be very well shielded to eliminate electromagnetic interference.

Additionally, closer proximity between the transformer, the multiplier, and the EMI shielding greatly increases the stray capacitance between the power supply components and the shields. This increased capacitance has several detrimental effects. First, since the transformer operates at relatively high frequency, increased stray capacitance results in a much larger current circulating in the resonant circuit formed by the magnetizing or leakage inductance of the transformer and the stray capacitance. This larger current causes large Joule heating losses in the equivalent resistance of the secondary winding, and in the primary winding equivalent resistance due to the transformed secondary current in the primary winding. The increased capacitance also reduces the frequency of operation of the system, as the frequency is determined by the resonant frequency of the transformer inductance and the total load capacitance.

Miniature high voltage power supplies for X-ray tube excitation also suffer from several limitations that limit power efficiency. The very high volt-microsecond integral of the transformer output, coupled with the need for minimal size, generally increases both the ferrite and copper losses that reduces efficiency. For example, a multistage Cockcroft-Walton multiplier used to convert the approximately 5000 Vpp output of the transformer to −50 kVdc is very sensitive to the total number of stages and the stray capacitance to ground with respect to power efficiency.

The drive electronics for the transformer can either utilize parallel or series resonance modes for excitation. A parallel drive design provides higher efficiency, but the required circuitry to keep the system operating at exactly the resonant frequency as the load changes may be quite complex, and can occupy a significantly larger footprint than a series resonant design. Additionally, as these X-ray sources are utilized in close proximity to extremely sensitive charge amplifiers for X-ray detectors, they need to have very low EMI emissions and thus be very well shielded. Compromises of many of the requirements described above may be required as the design becomes increasingly miniaturized.

A series resonant system that utilizes the resonance between the leakage inductance of the secondary winding of the transformer and the total load capacitance operates off resonance, and can thus tolerate large changes of resonance while operating at a fixed frequency. This vastly simplifies the driver circuitry, but requires a transformer that has low resistance in both the primary and secondary windings, as a large current flows at all times. This generally requires a larger transformer to be able to operate at high frequency and high efficiency.

Many series resonant transformer designs created for cold cathode fluorescent lamp (CCFL) operation include an open frame core type of design that generate a lot of EMI and are sensitive to their proximity to shielding. A pot core type transformer is much better than open frame core type transformer at containing EMI and tolerating adjacent shielding, but because of its very high coupling coefficient it is difficult to achieve a leakage inductance low enough for the desired operating resonant frequency without resorting to very large numbers of turns in the secondary winding. This can lead to high transformer resistances, which compromise efficiency.

It would therefore be desirable to provide a series resonant transformer design that reduces or overcomes some or all of the difficulties in prior known designs. Particular objects and advantages will be apparent to those skilled in the art, that is, those who are knowledgeable or experienced in this field of technology, in view of the following disclosure and detailed description of certain embodiments.

### SUMMARY

In accordance with a first aspect, a pot core transformer assembly includes a multiplier comprising a pair of single layer capacitors connected by a pair of high voltage diodes. A pot core transformer is connected in series with the multiplier, and includes a first core half having a first projection, and a second core half having a second projection spaced from the first projection by a first gap. A primary winding is wrapped about the first projection, and a secondary winding wrapped about the second projection. A magnetic shunt is positioned between the first core half and the second core half, and includes a central aperture receiving a portion of the first projection and a portion of the second projection. A second gap is formed between an outer peripheral surface of the magnetic shunt and an interior surface of the first core half and an interior surface of the second core half.

These and additional features and advantages disclosed here will be further understood from the following detailed disclosure of certain embodiments, the drawings thereof, and from the claims.

### BRIEF DESCRIPTION OF THE DRAWINGS

The foregoing and other features and advantages of the present embodiments will be more fully understood from the following detailed description of illustrative embodiments taken in conjunction with the accompanying drawings in which:

FIG. 1 is a section view of a pot core transformer with a magnetic shunt.

FIG. 2 is a circuit diagram of a circuit with the pot core transformer of FIG. 1 used in a simulation program.

FIGS. 3A-C illustrate primary currents from the simulation program used with the circuit of FIG. 2.

FIG. 4 is a graph illustrating performance of the pot core transformer of FIG. 1 in an actual circuit.

FIG. 5 is a schematic drawing of a miniature x-ray source with a high voltage generator.

FIG. 6 is a schematic drawing of the high voltage generator of FIG. 5 shown with a pot core transformer.

The figures referred to above are not drawn necessarily to scale, should be understood to provide a representation of particular embodiments, and are merely conceptual in nature and illustrative of the principles involved. Some features depicted in the drawings have been enlarged or distorted relative to others to facilitate explanation and understanding. The same reference numbers are used in the drawings for similar or identical components and features shown in various alternative embodiments. Transformers as disclosed herein would have configurations and components determined, in part, by the intended application and environment in which they are used.

### DETAILED DESCRIPTION OF EMBODIMENTS

Although a pot core transformer has numerous advantages, it would be desirable to improve its size, efficiency, and operating frequency. If sufficient turns are put in a standard pot core to achieve the desired leakage inductance and operating frequency, the copper losses may exceed the core losses by orders of magnitude. If the turns are minimized to balance the copper and core losses as is usually done, the leakage inductance becomes quite small, resulting in an operating frequency that is much too high. Increasing the leakage inductance will, therefore, help produce a transformer with a more desirable operating frequency. Thus, a goal is to find a way to manipulate the coupling coefficient of the transformer and thus the operating frequency independent of the number of turns in the transformer. Managing the pot core intrinsic coupling coefficient would be helpful in adapting a pot core transformer to achieve the objectives discussed above.

It is to be appreciated that a miniature configuration high voltage dc-dc converter may include a small pot core transformer followed by a multiplier consisting of two stacks of disc shaped single layer capacitors (SLC's) with high voltage diodes connecting the two stacks. SLC's are very robust and reliable compared to multi-layer capacitors, but have significantly less capacitance. This means the operating frequency must be higher, which generally reduces the efficiency. If the stacks can be separated by a centimeter or so, the stray capacitance can be minimized, but that is not compatible with the miniature configuration. Additionally, the multiplier must be installed in an electromagnetically shielded enclosure that is as small as possible, which also increases the stray capacitance. Stray capacitance is significant, as the circulating current through the stray capacitance can dwarf the current due to the X-ray tube load, and can lead to large Joule heating losses in the high voltage transformer.

The ideal operating frequency for the miniature multiplier stack configuration is between approximately 80 and approximately 100 kHz. Operating at a higher frequency increases the resonant current in the secondary of the transformer through the stray capacitance too much, and operating below this frequency requires a much higher drive ac voltage for the same output voltage, thereby increasing the power losses. A series resonant system for this frequency range would need a resonant frequency of approximately 120 kHz. Operating near, but not at, the resonant frequency increases the voltage gain of the transformer, and filters the output waveform for better EMI performance.

The term “approximately” as used herein is meant to mean close to, or about a particular value, within the constraints of sensible commercial engineering objectives, costs, manufacturing tolerances, and capabilities in the field of transformer manufacturing and use. In certain embodiments, the term “approximately” preceding stated or nominal values means +/−5% of the stated or nominal value unless stated otherwise Similarly, the term “substantially” as used herein is meant to mean mostly, or almost the same as, within the constraints of sensible commercial engineering objectives, costs, manufacturing tolerances, and capabilities in the field of transformer manufacturing and use.

It is to be appreciated that achieving the desired operating frequency with a typical stray capacitance of 13 pF in a shielded SLC multiplier configuration requires a leakage inductance on the secondary of approximately 0.1 H. This is virtually impossible to obtain in a conventional pot core with a practical number of turns of secondary wire, due to the very tight coupling of the pot core configuration. The number of secondary turns is so high, and the required wire gauge is so small, that the power losses in the secondary are enormous.

It has been found that the coupling coefficient of a transformer can be reduced by putting a magnetic shunt between the primary and secondary windings. A magnetic shunt with a gap, and a pot core with a gap, can be tuned to achieve a relatively low coupling coefficient. The magnetic shunt can increase leakage inductance and limit current without dissipating power, thereby improving efficiency.

For example, a magnetic shunt configuration was tried with a shielded SLC multiplier, and it was possible to get the resonant frequency around 130 kHz with just 1100 turns of wire on the secondary winding. It was found that the efficiency shot up dramatically; from about 75% for an open frame transformer to over 90% for the magnetically shunted pot core transformer. The increased performance was due to the primary winding current being reduced dramatically for the same output power. Primary winding current circulating through the primary winding resistance is a source of power loss. There are two components of current in the primary winding: the current through the magnetizing inductance of the primary winding, and the reflected secondary winding current. Both of these currents are on the order of several Amperes rms (Aᵣₘₛ), and cause hundreds of milliwatts of power loss. However, in this application, the magnetizing current lags the drive voltage by 90 degrees, and the reflected secondary winding current leads the drive voltage by 90 degrees, thus the two currents are 180 degrees out of phase. If the transformer coupling is optimized by adjusting the thickness of the magnetic shunt and the width of the two gaps, an operating point can be achieved where the magnetizing current and the reflected secondary winding current are approximately the same magnitude. Since the two currents are out of phase, the resulting current circulating in the primary winding is significantly reduced, and thus the power loss in the primary drops dramatically.

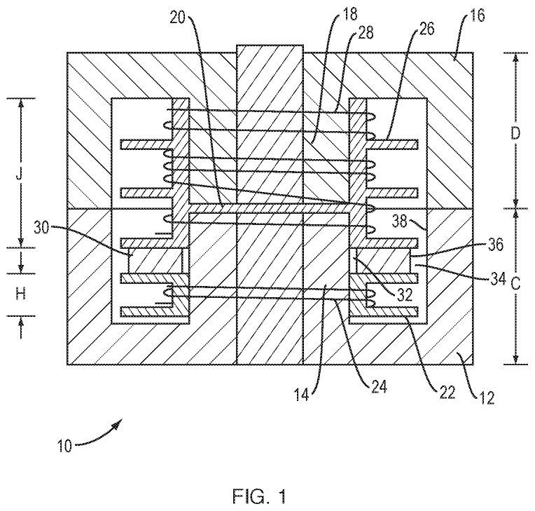

Referring to FIG. 1, a pot core transformer 10 may include a first core half 12 including a first projection 14, and an opposed second core half 16 may include a second projection 18. First core half 12 may have a height C of approximately 10 mm, and second core half 16 may have a height D of approximately 10 mm. First projection 14 may be spaced from second projection 18 to define a first gap 20 therebetween. In certain embodiments, first gap 20 may be between approximately 0.1 mm and approximately 1 mm. A first bobbin 22 may be positioned about first projection 14, and a primary winding 24 may be wrapped about first bobbin 22. A second bobbin 26 may be positioned about second projection 18, and a secondary winding 28 may be wrapped about second bobbin 26. In certain embodiments, first bobbin 22 has a height H that is greater than a height J of second bobbin 26. In certain embodiments, height H may be between approximately 2 mm and approximately 5 mm, and height J may be between approximately 4 mm and approximately 10 mm.

A magnetic shunt 30 may be positioned between first bobbin 22 with primary winding 24 and second bobbin 26 with secondary winding 28. Magnetic shunt 30 may be disk-shaped and include a central aperture 32 that receives a portion of first projection 14. Magnetic shunt 30 may have an outer diameter that is sized slightly smaller than an inner diameter of first core half 12 such that a second gap 34 is formed between an exterior peripheral surface 36 of magnetic shunt 30 and an interior surface 38 of first core half 12. In certain embodiments, second gap 34 may be between approximately 0.5 mm and approximately 3 mm. In certain embodiments, magnetic shunt 30 may be formed of ferrite, and may have a thickness of about 1 mm, or formed of Metglas®, and may have a thickness of about 0.05 mm.

In certain embodiments, the number of turns for secondary winding 28 is approximately 1100 turns of No. 40 AWG wire, with a leakage inductance of approximately 100 mH. This is in sharp contrast to the approximately 2000 turns of No. 44 AWG wire having a leakage inductance of approximately 35 mH for a typical open frame transformer. In certain embodiments, testing showed an increase in efficiency from approximately 75% for an open frame transformer to almost 90%. Additionally, a reduction in the reflected secondary resonance current in the primary winding 24 from approximately 2.5 Aᵣₘₛ to 1.5 Aᵣₘₛ was realized, which reduced the primary winding dissipation by more than approximately 60%. This, in conjunction with the lower secondary winding 28 Joule heating due to fewer turns and increased wire gauge, was found to be the reason for the jump in efficiency.

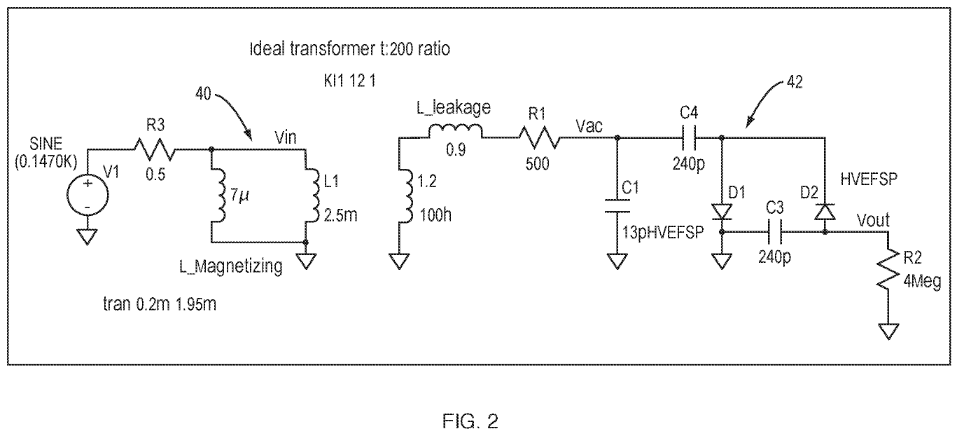

A schematic representation of a circuit 40 used in a Simulation Program with Integrated Circuit Emphasis (“SPICE”) incorporating pot core transformer 10 is illustrated in FIG. 2. It is to be appreciated that the magnetizing and leakage inductances are modeled as external inductors, and the step up ratio is provided by an ideal transformer with inductances large enough to have negligible effect. As noted above, a multiplier 42 including two stacks of disc shaped SLC's C3 and C4 are connected by high voltage diodes D1 and D2. A 500 Ohm resistor R1 is positioned upstream of multiplier 42, while a 4 Meg Ohm resistor R2 is positioned downstream of multiplier 42. A voltage drive is in series with a 0.05 Ohm resistor R3 upstream of the transformer.

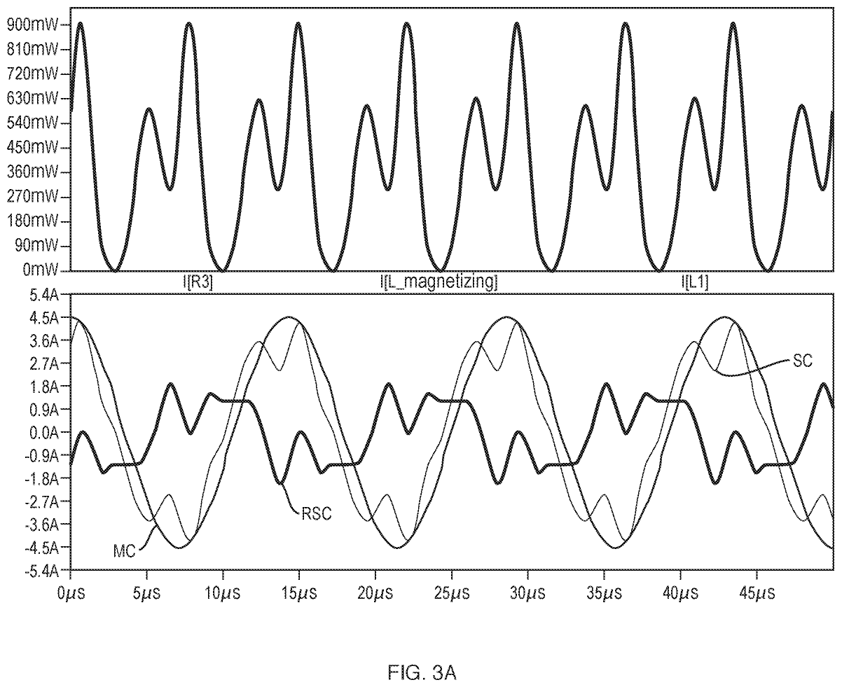

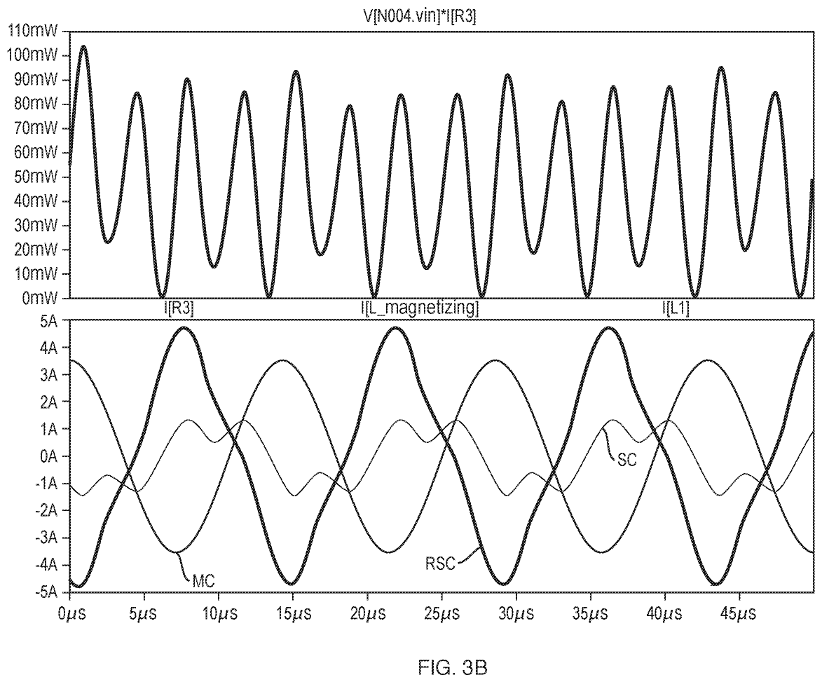

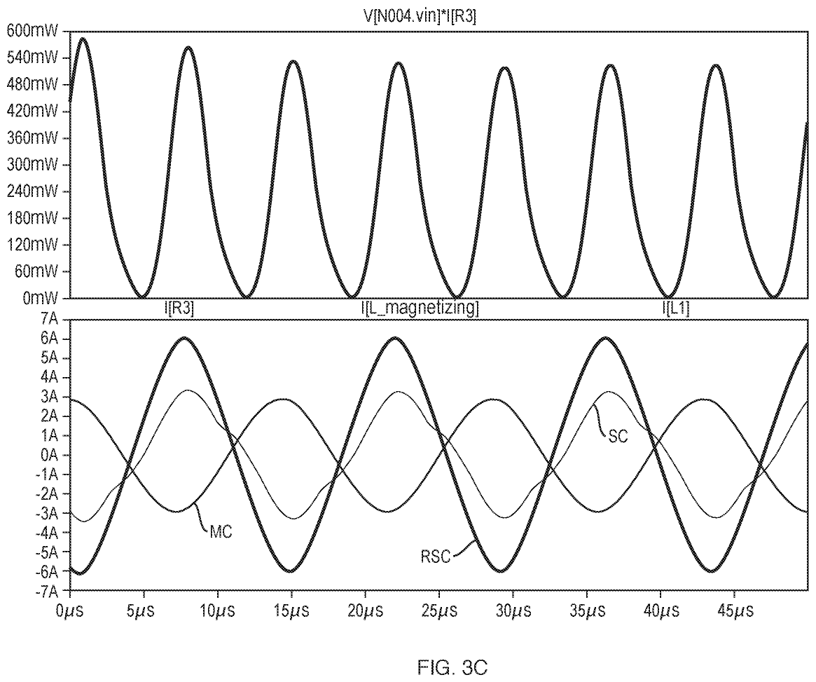

The resultant primary winding currents from the SPICE simulation are illustrated in FIGS. 3A-C, for a low stray capacitance of 2 pF, as shown in FIG. 3A, for a nominal stray capacitance of 13 pF, as shown in FIG. 3B, and for a high stray capacitance of 20 pF, as shown in FIG. 3C. Primary winding power dissipation is measured by calculating the power dissipation in the 0.05 Ohm resistor R3 in series with the voltage drive, for an output of 5 kV. For C1=2 pF, as shown in FIG. 3A, the power dissipation is approximately 380 mW. For C1=13 pF, as shown in FIG. 3B, the power dissipation is approximately 46 mW. For C1=20 pF, as shown in FIG. 3C, the power dissipation is approximately 228 mW. It is clear that the dissipation is minimal at the stray capacitance of the SLC multiplier. The top trace in the current graphs shows the power dissipation in the primary resistance, while the bottom trace shows the magnetizing current MC, the reflected secondary current RSC, and the sum current SC. It can be seen that the sum current is minimized at the stray capacitance value of 13 pF, illustrated in FIG. 3B.

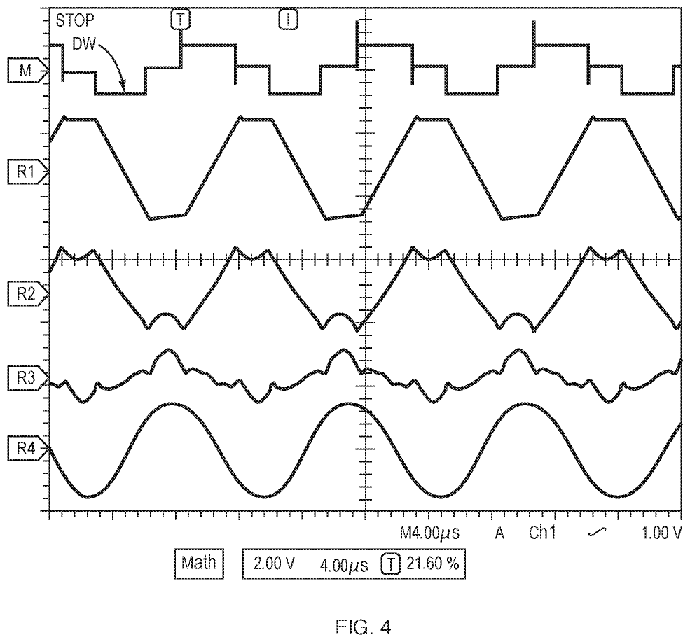

A measurement of the actual circuit was conducted to see how close the SPICE simulation matched the real world performance of the circuit, and is illustrated in FIG. 4. Illustrated here are the drive waveform DW and the primary magnetizing current R1. R2 shows the current with both the primary and the secondary windings installed in the pot core, but no load. R3 shows the current with 11 pF as a load, and R4 shows the current with 22 pF as a load. Current is 4 A/div, except R4 is 20 A/div. It is clear that the lowest primary current, and thus the highest efficiency, is the condition where the load capacitance equals the equivalent capacitance for the SLC multiplier. This effect can be tuned for the effective load capacitance by adjusting the parameters of the pot core elements, the magnetic shunt, and the number of turns. By using a magnetic shunt in a pot core transformer, you can achieve very high efficiency by adjusting the reflected secondary current to minimize the primary loss, you can reduce the operating frequency and number of secondary turns to decrease the loss in the secondary, and the ability to independently adjust the leakage inductance allows the circuit to compensate for high stray capacitance due to the close proximity of components and shielding.

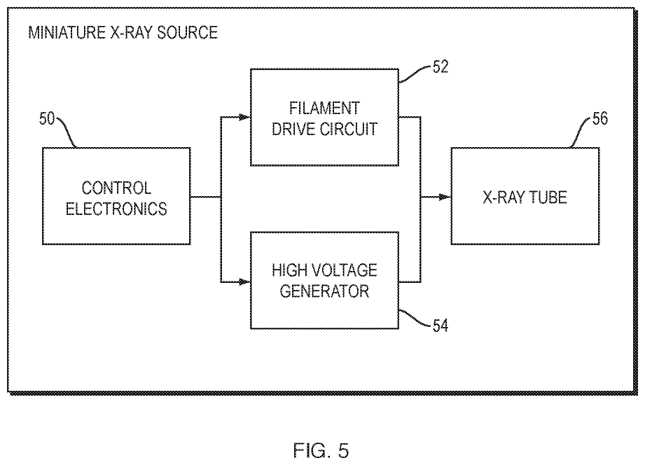

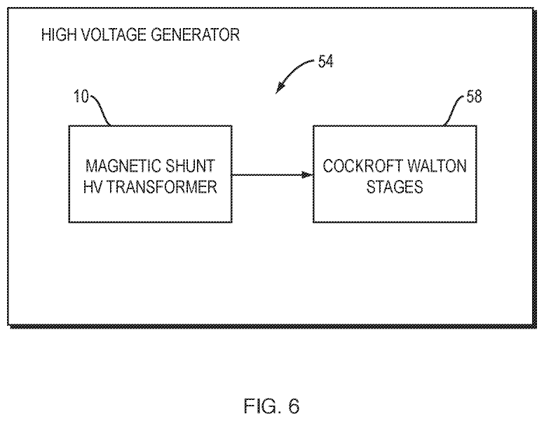

A miniature high voltage power supply for an X-ray tube is illustrated in FIGS. 5-6. As seen in FIG. 5, a miniature X-ray source includes control electronics 50 for a filament drive circuit 52 and a high voltage generator 54, each of which is operably connected to an x-ray tube 56. As seen in FIG. 5, high voltage generator 54 includes pot core transformer 10 and subsequent Cockcroft Walton stages 58.

Providing a multiplier with SLC's and a proximal shield and thus high stray capacitance, and a pot core high voltage transformer with a magnetic shunt, can result in a miniaturized 50 kVdc high voltage power supply with superior efficiency, EMI performance, and volumetric efficiency compared to previous art power supplies.

Those having skill in the art, with the knowledge gained from the present disclosure, will recognize that various changes can be made to the disclosed apparatuses and methods in attaining these and other advantages, without departing from the scope of the present invention. As such, it should be understood that the features described herein are susceptible to modification, alteration, changes, or substitution. For example, it is expressly intended that all combinations of those elements and/or steps which perform substantially the same function, in substantially the same way, to achieve the same results are within the scope of the invention. Substitutions of elements from one described embodiment to another are also fully intended and contemplated. The specific embodiments illustrated and described herein are for illustrative purposes only, and not limiting of the invention as set forth in the appended claims. Other embodiments will be evident to those of skill in the art. It should be understood that the foregoing description is provided for clarity only and is merely exemplary. The spirit and scope of the present invention are not limited to the above examples, but are encompassed by the following claims.

What is claimed is:

1. A pot core transformer assembly comprising:
a multiplier comprising a pair of single layer capacitors connected by a pair of high voltage diodes;
a pot core transformer connected in series with the multiplier, the pot core transformer comprising:
a first core half having a first projection;
a second core half having a second projection spaced from the first projection by a first gap;
a primary winding wrapped about the first projection;
a secondary winding wrapped about the second projection;
a magnetic shunt positioned between the first core half and the second core half, and including a central aperture receiving a portion of the first projection and a portion of the second projection;
a second gap formed between an outer peripheral surface of the magnetic shunt and an interior surface of the first core half and an interior surface of the second core half.

2. The assembly of claim 1, further comprising a first bobbin positioned in the first core half, the primary winding being wrapped about the first bobbin.

3. The assembly of claim 1, further comprising a second bobbin positioned in the second core half, the secondary winding being wrapped about the second bobbin.

4. The assembly of claim 1, wherein the secondary winding includes approximately 1100 turns.

5. The assembly of claim 1, wherein the secondary winding is formed of No. 40 AWG wire.

6. The assembly of claim 1, wherein the magnetic shunt is disk-shaped.

7. The assembly of claim 1, wherein the magnetic shunt is formed of ferrite.

8. The assembly of claim 1, wherein the magnetic shunt has a thickness of approximately 1 mm.

9. The assembly of claim 1, wherein the first gap is approximately 1 mm.

10. The assembly of claim 1, wherein the second gap is approximately 1 mm.

11. The assembly of claim 1, further comprising a first resistor in series with the pot core transformer.

12. The assembly of claim 1, further comprising a second resistor upstream of the multiplier and a third resistor downstream of the multiplier.

13. A miniature x-ray source comprising
a high voltage system further comprising
a pot core transformer assembly:
a multiplier comprising a pair of single layer capacitors connected by a pair of high voltage diodes;
a pot core transformer connected in series with the multiplier, the pot core transformer comprising:
a first core half having a first projection;
a second core half having a second projection spaced from the first projection by a first gap;
a primary winding wrapped about the first projection;
a secondary winding wrapped about the second projection;
a magnetic shunt positioned between the first core half and the second core half, and including a central aperture receiving a portion of the first projection and a portion of the second projection;
a second gap formed between an outer peripheral surface of the magnetic shunt and an interior surface of the first core half and an interior surface of the second core half;
a filament drive circuit, and
an x-ray tube.
